(19) United States
(12) Patent Application Publication
(10) Pub. No.: US 2010/0153569 A1
(43) Pub. Date: Jun. 17, 2010

(54) System and Method for a Virtual Hosted Operating System

(75) Inventor: Zvi Schreiber, Jerusalem (IL)

Correspondence Address: SIMON KAHN - PYI Tech, Ltd.;c/o LANDONIP, INC, 1725 Jamieson Avenue, ALEXANDRIA, VA, 22314, US

(73) Assignee: GHOST, INC., Tortola (VG)

(21) Appl. No.: 12/530,465

(22) PCT Filed: Mar. 9, 2008
(86) PCT No.: PCT/IL08/00318

§ 371 Date: Feb. 6, 2010

Related U.S. Application Data
(60) Provisional application No. 60/893,968, filed on Mar. 9, 2007.

(51) Int. Cl. G06F 15/16; H04L 9/32; G06Q 30/00; G06Q 50/00

(52) U.S. Cl. 709/229; 726/8; 705/14.69

(57) ABSTRACT

A system and method enabling a virtual hosted operating system which provides many of the functions normally associated with a physical computer as a “virtual computer” service available from a web browser by leveraging and seamlessly aggregating third-party web services.

### CROSS-REFERENCE TO RELATED APPLICATIONS

This application claims priority from U.S. Provisional Patent Application Ser. No. 60/893,968 filed Mar. 9, 2007, entitled “VIRTUAL HOSTED OPERATING SYSTEM” the entire contents of which is incorporated herein by reference.

This application is further related to the following co-pending, co-filed and co-assigned patent applications, the entire contents of each of which are incorporated herein in their entirety by reference: “A VIRTUAL IDENTITY SYSTEM AND METHOD FOR WEB SERVICES”, docket GHO-005-PCT; “VIRTUAL FILE SYSTEM FOR THE WEB”, docket GHO-006-PCT; “A GENERAL OBJECT GRAPH FOR WEB USERS”, docket GHO-007-PCT; and “SYSTEM AND METHOD FOR BROWSER WITHIN A WEB SITE AND PROXY SERVER”, docket GHO-008-PCT.

### BACKGROUND OF THE INVENTION

Historically computers had limited or no connectivity to a broad fast network such as the Internet. Each computer therefore had its own operating system (such as DOS, Microsoft Windows™, Linux, Unix, Max OS X) and a user's applications and data were stored locally over the computer's operating system. Today many computers have high speed “always-on” connections to the Internet. Some software is available hosted as a service over the Internet instead of being installed locally including:

Web mail such as Hotmail from Microsoft Inc. of Redmond, Wash.;

Hosted games such as Yahoo! Games from Yahoo! Inc. of Sunnyvale, Calif.;

Photo management and sharing application such as Rich from Yahoo! Inc.; and

Hosted spreadsheets such as Google Spreadsheets from Google Inc. of Mountainview, Calif.

To use these programs the user does not require a full personal computer and operating system, such as Microsoft Windows™, but may instead use more limited hardware such as a “Thin Client”, i.e. a computer without a hard disk, and a more limited operating system such as a subset of Linux, provided only that they are able to run an Internet browser such as Microsoft Internet Explorer™ or Mozilla Firefox™.

However a difficulty arises in that some of the traditional roles of an operating system are absent when running software applications as a service instead of locally. The user interacting with multiple hosted software applications or services may in some ways have an inferior experience to the user interacting with multiple locally installed software applications which are at least united by a ‘local’ operating system.

Some limited hosted operating system services are currently available (such as those at http://goowy.com, http://youos.com, http://desktoptwo.com, http://startforce.com). However, these systems have several limitations which have prevented their widespread adoption. Limitations may include inter alia:

Limitation of the applications which can be run on the hosted operating system to those developed together with the hosted operating system or to those hosted together with the hosted operating system (e.g. on the same server computers or at least at the same domain such as hostedoperatingsystem.com) or to those hosted elsewhere but available anonymously without login—in other words the hosted operating system lacks virtualization and must be physically coupled to all the applications which it runs from a user perspective;

The lack of a good business method to finance the hosted operating system and to finance its continued development;

The lack of a virtual file system—the user must either store all their data files with one service provider or, if the user has them with many service providers, the user will not receive any ‘file system’ services such as, without limitation, single-sign-on, common folders, search across the file systems, folder and file permissions;

The lack of rich data interoperability between applications, at most the user can copy and paste text, and the lack of a rich way to discover and navigate new data objects and to use data objects for social networking;

The lack of a single-sign-on mechanism to allow navigation from the hosted operating system to third party software hosted elsewhere without the need for repeated authentication with username and password and without the need to repeatedly set user preferences such as language;

Lack of a general authorization scheme; to support effective, controlled secure sharing of data between users; and

Lack of an effective browser application embedded within the web site of the hosted operating system (specifically if there is a browser at all it is ineffective in that some hyperlinks may cause the hosted operating system desktop to be overridden and in that there is no ability to capture bookmarks or to capture the user's cookies from sessions to session between machines).

It is to be understood that the above list of limitations and desired functions are not meant to be limiting in any way. There is therefore a need for a hosted operating system which will help the user interact efficiently with multiple hosted software services

### SUMMARY OF THE INVENTION

The invention introduces the novel concept of a virtual hosted operating system which is virtual in the sense that the main resources available to the user within the operating system are actually hosted by third-parties not directly related to the virtual hosted operating system and are nonetheless aggregated by the virtual hosted operating system in such as a way as to give the user a seamless experience using these resources just as easily as if they were all hosted by the same service provider or even as easily as if they were all installed on the user's physical computer.

Specifically the resources which are aggregated by the virtual hosted operating system on behalf of the user may include without limitation some or all of the following:
Aggregating hosted web applications which are developed and hosted from third parties (such as, among others, webmail programs, web photo albums, web document editors and web media players), thereby allowing the hosted web applications to be discovered and launched from within the virtual hosted operating system client and allowing interoperability such as giving the applications access to the user's data and files when desired;
Aggregating file system web services hosted by third-parties, even though they may use different technologies and have different capabilities and allowing the user to mount them as “drives” using a consistent interface and optionally providing features such as search across the drives and interoperability such as dragging files between the drives;
Providing the user with a browser within the client web page, i.e. within the web page which constitutes the virtual hosted operating system, in order that the user can browser third-party web sites as they would from Windows desktop;
Aggregating data web services hosted by third-parties, such as without limitation contact data, product data, location data, directories of web sites data, directories of web applications data, data on geographical locations, even though they may use different technologies and have different capabilities, and allowing the user to navigate the data as if it was one object graph and preferably giving the user graphical icons to represent pointers to data including third party data and facilities to search across the different data sources and interoperability such as moving data between data sources; and
Managing the user's identities so that they can access third party web sites, web applications, file systems and data without having to explicitly login to each site each time.

In addition the present invention includes a business method appropriate to the specific needs of financing a virtual hosted operating system.

In certain embodiments the invention provides for a virtual hosted operating system comprising: a data center; and a client code downloaded from the data center to a terminal for rendering a user desktop, wherein the downloaded client code is operative to: launch a plurality of third-party web applications; and visually couple the third-party web applications to the user desktop, and wherein the data center is operative to perform authentication to at least one of the plurality of third-party web applications.

In one further embodiment the client code is downloaded dynamically to a browser running on the terminal and executed inside the browser. In another further embodiment the data center includes a repository of user's login credential to third party web sites. In one yet further embodiment the data center further comprises a single-sign-on functionality operative to automatically authenticate a user to third-party web services hosting the third party web applications.

In one further embodiment the client code comprises a browser-within-a-web-page. In one yet further embodiment the data center comprises a proxy server functionality, and wherein the browser-within-a-web-page communicates with the third-party web applications via the proxy server. In one yet further embodiment the proxy server functionality comprises a cookies store, and the proxy server is operative to store cookies from the third party web applications in the cookies store.

In one further embodiment the client code is further operative to provide a virtual file system providing consistent access within the desktop to a plurality of technically incompatible hosted file systems. In one yet further embodiment the client code is further operative to mount a hosted file system as a drive. In one yet even further embodiment the client code comprises a federated general object graph operative to allow the user to navigate disparate third-party data sources.

In one further embodiment the virtual hosted operating system includes a persistence service operative to capture and reconstitute the state of the client code. In one yet further embodiment third-party applications may store data in the persistence service.

In certain embodiments the invention independently provides for a business method for financing a virtual hosted operating system comprising: hosting a desktop program which may be downloaded free-of-charge by users; allowing users to access multiple hosted services referred via the desktop; and charging at least one hosted service for receiving referrals.

In one further embodiment the hosted services includes at least one commercial service and at least one non-commercial service, and wherein the at least one hosted service which is charged is the at least one commercial service. In another further embodiment the charge is a proportion of a measure of the revenue of the at least one hosted service. In another further embodiment the charge is per referral. In yet another further embodiment the charge is per unique user referred.

In one further embodiment a proportion of the charge is paid to at least one non-commercial service. In another further embodiment a proportion of the charge is paid to at least one contributor to the hosted operating system technology or a provider of a free service.

In certain embodiments the invention independently provides for a system for administering the finances of a hosted operating system comprising: a hosted desktop program which may be downloaded free-of-charge by users; a mechanism for referring users from the desktop program to at least two third-party hosted services; and a billing system which charges the at least two hosted services for receiving referrals.

In certain embodiments the invention independently provides for a method of implementing a virtual hosted operating system, the method comprising: providing a downloadable client code at a data center, the client code being operative to: render a user desktop on a terminal to which it has been downloaded; launching a plurality of third-party web applications; visually couple the third-party web applications to the user desktop, and performing automatic authentication from the data center to at least one of the plurality of third-party web applications.

In one further embodiment the method further comprises: dynamically downloading the client code to a browser; and executing the client code inside the browser. In another further embodiment the method further comprises storing, at the data center, a repository of user's login credential to third party web sites, the preformed automatic authentication being responsive to the stored repository.

In one further embodiment the client code comprises a browser-within-a-web-page. In one yet further embodiment the method further comprises providing, at the data center, a proxy server functionality; and communicating between the browser-within-a-web-page and the third-party web applications via the proxy server. In one even further embodiment the method further comprises storing, at the data center, cookies from the third party web applications.

In one further embodiment the client code is further operative to provide a virtual file system providing consistent access within the desktop to a plurality of technically incompatible hosted file systems. In one yet further embodiment client code is further operative to mount a hosted file system as a drive. In one even further embodiment the client code comprises a federated general object graph operative to allow the user to navigate disparate third-party data sources.

In one further embodiment the method further comprises capturing and reconstituting the state of the client code. In one yet further embodiment the method further comprises storing, at the data center, data from the third party web applications.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates a high level block diagram of an embodiment of the invention;

FIG. 2 illustrates an embodiment of user interface for the desktop rendered by the client according to the invention, and further illustrating a browser-within-a-web-page displaying a third-party web site in an iframe; and

FIG. 3 illustrates a high level flow chart of an embodiment of a method of financing a virtual hosted operating system according to a principle of the invention.

### DETAILED DESCRIPTION OF THE PREFERRED EMBODIMENTS

The present embodiments enable a virtual hosted operating system which provides many of the functions normally associated with a physical computer as a “virtual computer” service available from a web browser by leveraging and seamlessly aggregating third-party web services. In certain embodiments the functions provided include a desktop, a file system, lists of applications and the means for maintaining user settings.

It should be emphasized that a hosted operating system (also known as a Web operating system, Web desktop or Webtop) is not an operating system in the sense of managing the local hardware, as it does not include drivers for, inter alia, the disk, keyboard, screen and mouse. Local hardware drivers, as required, are supplied by a minimal local operating system supplied for every computer. Certain embodiments of the Web operating system provide a hosted alternative to the higher levels of the traditional operating systems such as graphical desktop, file system, application management, user authentication and authorization.

Some of the functions which are supported in certain embodiments of the hosted operating system according to the invention include are listed below.

Desktop—a graphical user interface for organizing files, for finding, launching and managing application programs and small programs (known as widgets), for setting user preferences. In one particular embodiment the desktop includes a start menu, a taskbar, windows and icons. In one particular embodiment the desktop runs in a Web browser so that it may run on almost any computer without the need to install software. Preferably the states of the desktop, including which windows are open and to what application, are persisted from session to session so a user can work in one browser and continue from the same state in a different browser.

Hosted file system—providing storage and organization of files for each user over the Web.

Virtual file system—giving the user a single interface into third-party Web file storage services.

Application programs (apps)—may be bundled with the hosted operating system but preferably the user is given more choice by enabling the embedding of third-party applications for purposes such as productivity, including document editing, communications and entertainment.

Interoperability, so that different applications can use the hosted file system or the virtual file system. In one particular embodiment the hosted operating system provides a service for matching different types of stored files with the appropriate hosted editor software, e.g. matching a stored photo with a service such Yahoo! Inc.'s Flickr service at www.flickr.com, for editing and organizing photos. In such an embodiment, double clicking on an icon representing an image file causes Flickr to be launched.

Application standards—some standards for Graphical User Interfaces (GUIs) to create a consistent application look & feel across multiple hosted software services.

Application interoperability—for example a clipboard (copy & paste) and drag-and-drop for better interoperability between hosted software services, including support for structured data objects in addition to text.

Other common services—for example, common billing, common contacts, common address book, common calendar, common mapping, and any other service which is common to more than one hosted service and where the user benefits from greater compatibility or data sharing

Common data—preferably using an object-oriented graph of data objects, e.g. common reference data like lists of countries, languages, user data, and general data like data on people, products (say books, movies) which might be of common interest to more than one application; preferably a federated object graph is supported which incorporates objects stored by third-parties

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

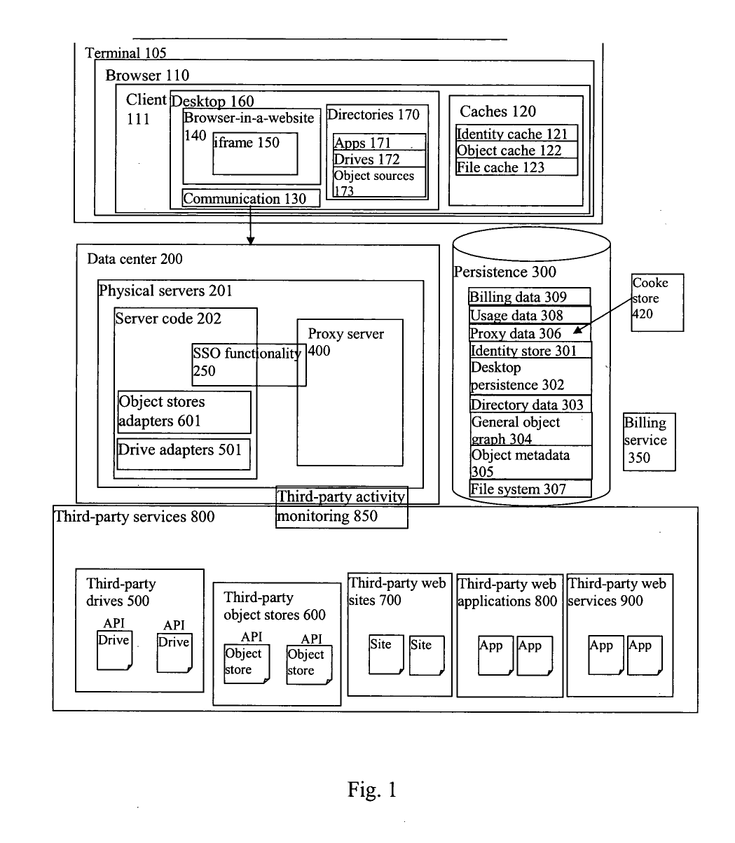

The overall design of the system may be understood with reference to FIG. 1, which illustrates a high level block diagram of an embodiment of the invention comprising: a terminal 105; a data center 200; a persistence service 300; a billing service 350; third party activity monitoring 850 and third party services 800. Terminal 150, which preferably is constituted of a processor, memory, monitor and user input device (not shown), runs browser 110. Terminal 105 is in one embodiment a personal computer, and in other embodiments any other device capable of running software and of user input/output and preferably capable of running a web browser, such as a thin-client computer, mobile phone or a set-top-box. Browser 110 is operative to download, or have otherwise installed therein, a Client 111.

Data center 200 is a logical collection of computing resource not necessarily in one location and preferably, but not necessarily, associated with a virtual-hosted-operating-system web domain. Data center 200 comprises a plurality of physical servers 201. Physical servers 201 run a server code 202 and a proxy server functionality 400. Proxy server functionality 400 may be constituted of a dedicated one of physical servers 201, or as a particular functionality supported by one or more of physical servers 201 by virtue of a portion of software code. Proxy server functionality 400 comprises a cookie store 420, operative to store received cookies from third party services 800. The stored cookies are in one embodiment forwarded to Client 111 encapsulated, and in another embodiment appended to HTTP requests forward from Client 111, as further described in co-pending patent application “SYSTEM AND METHOD FOR BROWSER WITHIN A WEB SITE AND PROXY SERVER”, the entire contents of which is incorporated by reference.

In one embodiment, Client 111 is downloaded from data center 200. In one further embodiment, Client 111 is downloaded from server code 202. Server code 202 preferably includes web server or application server functionality running on or more of physical servers 201. Preferably Client 111 comprises a web page which is preferably downloaded on-demand into a browser 110 when a user navigates to a URL associated with the virtual hosted operating system. In one embodiment Client 111 includes executable code in a language executable by a browser, such as Flash, Javascript+DHTML known as AJAX, Silverlight or Java applets and optionally generated from a higher-level language such as OpenLaszlo, to implement the functionality of the virtual hosted operating system. Alternatively, Client 111 may be installed software installed on Terminal 105.

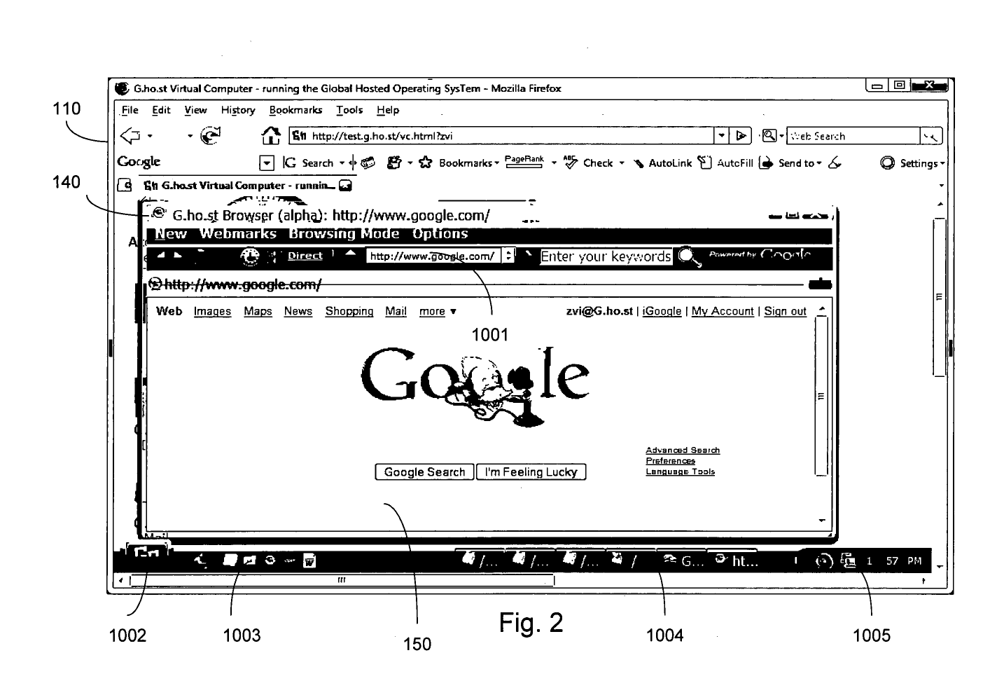

Preferably, Client 111 implements a desktop 160 which may be the main or only user-visible manifestation of Client 111, and as illustrated in FIG. 2 preferably include a start menu 1002, a quick launch 1003 for quickly launching the user's favorite files or folders, a task bar 1004 for listing and controlling running application windows and a system tray 1005.

Desktop 160 preferably renders within it background images, user icons, widgets (small applications which typically display behind windows), windows in which applications are running and other graphical elements such as, without limitation, menus, sounds, animation effects, pop-up dialogues and alerts.

Desktop is able to launch applications one of which is preferably a browser-within-a-web-page 140 where the user may indicate a web site of interest by inputting text into an input-text box 1001, or otherwise, and see a third-party web site rendered preferably using an HTML iframe 150, or similar construct.

By way of explanations, modern browsers often provide an HTML element called an iframe (and/or similar elements) which may be embedded in a first web site and which may be supplied with a URL by way of an attribute called ISRC which will direct the browser to load a second web site from the URL into the iframe. Although the first web site may control the ISRC parameter of the iframe, the browser will usually prohibit any communication between code from the first web site and code from the second web site if they are downloaded from different domains.

Client 111 preferably includes a communications module 130 for communicating with the server code 202 preferably using HTTP calls to an API implemented by server code 202 which API preferably implements the REST style or uses a remote procedure style like XML-RPC or SOAP or any other API technique known in the art. Preferably communications module 130 can route network calls via proxy server functionality 400 and can perform client-side single-sign-on (SSO), or can trigger server-side SSO using an SSO functionality 250 of server code 202 or of proxy server 400, as further described in co-pending patent applications referenced and incorporated above. SSO functionality is operative in cooperation with an ID repository 301 and/or identity cache 121, to supply identity information gathered from a user in advance (or a digest therefore) to third-party services 800, and stored at data center 200, thereby effecting an SSO.

Preferably Client 111 provides a set of directories 170 for finding resources which optionally include, without limitation, a directory of web applications 171, a directory of third-party hosted file systems known as drives 172 and a directory of third-party object stores 173. Data for directories 170 are persisted in persistence service 300 in directory data 303 and optionally an interactive directory is supported where users may themselves submit directory entries and may rate and comment on other entries.

Client 111 optionally includes a plurality of caches 120 for improving performance and for enabling offline work. Caches 120 optionally include, without limitation, a cache for the user's identity information 121, preferably including third-party usernames, passwords and optionally temporary session IDs, a cache for file systems 123, a cache for object data 122 including optionally objects stored as part of the virtual hosted operating system and/or objects aggregated from third-parties. Ca Cache for file systems 123 optionally includes caching of data from a hosted file system embedded in the virtual hosted operating system with main persistence 307 and/or third-party file systems, denoted drives 500, including without limitation, caching listings of the folder contents and/or file metadata and/or file content.

Client 111 is preferably able to launch third-party services 800 without limitation either by presenting the third-party's web interface inside iframes 150 or by providing a native interface for third-party services as part of desktop 160, and to optionally to render third-party web pages in browser-within-a-web-page 140.

In one embodiment server code 202 is implemented using any server-side programming techniques such as Java servlets, Java Enterprise Beans, .net, PHP, etc. and preferably includes, without limitation:
Web server functionality for downloading the code of Client 111;
Services exposed via an API to allow Client 111 to retrieve a desktop persistence state 302 for persistence service 300 for reconstituting desktop 160 including user preferences and the state of open windows, and to save the persistence periodically, upon change, or upon logout;
The business logic tier, as in the known 3-tier architecture of presentation/business logic/persistence, for desktop 160, directories 170 and specific applications;
Providing consistent APIs for access to third party hosted file system drives 500 either directly or via drive adapters 501;
Providing consistent APIs for access to third party hosted database object stores 600 either directly or via adapters 601.

In one embodiment persistence service 300 is realized by a relational database such as Oracle from Oracle Inc. of CA. or a hosted database service such as SimpleDB from Amazon Inc. of Seattle, Wash. Persistence service 300 provides persistence services both for the state of each users's Client 111, in order to preserve the desktop state and the full effect of a “virtual computer” between sessions, and general system data.

Persistence service 300 may include an identity store 301 with user's login credentials to third party services for single-sign-on and optionally temporary session IDs; persistence for the user's desktop and associated user preferences 302 as further described below; persistence with the content of directories 170 which content may be common to some or all users; persistence for an object graph 304 that may be specific to a user or common to users; and user metadata 305 for objects stored at third-parties 800. Optionally persistence service 300 may include persistence for a hosted file system 307, in addition to the third-party file system drives 501. Persistence service 300 may include data or statistics on user usage patterns 308 which might include, inter alia, a record of user logins, user logout, users launching applications, users changing settings and users accessing URLs, and which might be used to generate reports regarding system usage and statistics on user behavior. Persistence service 300 may also include billing data 309 which might include billing information for users and preferably includes information on revenues which third-party services 800 collect from users accessing third party services 800 via Client 111, and billing information for third-parties in accordance with the business method further detailed below.

For clarity purposes the detailed embodiment is described here in terms of overall assembly of the system. Further details of each aspect of the system may be found if required in co-pending applications, which are incorporated in full by reference.

A VIRTUAL IDENTITY SYSTEM AND METHOD FOR WEB SERVICES describes in detail identity cache 121, identity store 301 and a single-sign-on functionality to third-party services 800.

A VIRTUAL FILE SYSTEM FOR THE WEB describes drive adapters 501, the business logic in server code 202 for providing a consistent interface for the disparate drives 500 and for providing cross-drive functionality such as search, and further details the operation of Client 111 to providing mounting, navigating and usage of drives 500 as part of the user interface of desktop 160.

A GENERAL OBJECT GRAPH FOR WEB USERS describes General Object Graph 304 which may have a schema which changes at runtime and describes metadata 305 for external objects, such as those found in third party object stores 600, and describes how server code 202 and the adapters 601 may turn disparate data sources 600 into a Federated General Object Graph which may be navigated and edited as it if was a single graph. The application further describes the aspect of client 111 providing mounting, navigating and usage of data sources 600 as part of the user interface of desktop 160 including the use of icons in the desktop to indicate objects. The application further describes how the General Object Graph or Federated General Object Graph may be applied to application interoperability and social networking.

SYSTEM AND METHOD FOR BROWSER WITHIN A WEB SITE AND PROXY SERVER describes proxy server functionality 400 and browser-within-a-web-page 140 and the details of proxy data 306 optionally including storage for user cookies 420 (which further enhances the “virtual computer” experience by making a user's cookies available to them whichever terminal 105 they are using).

### Desktop Persistence

In order to persist the state of the desktop 160, in desktop persistence 302, an XML format may be employed. By way of non-limiting example, global user preferences like choice of language may be persisted as attributes in the root element. Configurable graphical user elements like start menu 1002 or quick launch 1003 may have their own branches in the tree, shown as <startMenu> and <quickLaunch> respectively. Running application windows may be listed as XML elements in a branch, such as <objects> below, and preferably each such XML element will have attributes capturing the state of the window, such as x and y position, width and height, title, and the third-party application running in the window may be given the ability to persist its state in further attributes and sub-elements.

The users's folders may also be persisted as part of the desktop state as an alternative embodiment to having separate file system storage 307.

An embodiment of desktop persistence in XML format is now presented as an example:

<userDesktop windowCount=″0″ globalWindowAndWidgetCount=″2″
language=″english″ taskBarPosition=″1″
desktopBackground=″http://G.ho.st/Ghost/desktopBackgrounds/ghost
DefaultWallpaper.png″ colorchoice=″green″>

<startMenu>

<resource notCategory=″true″>

<object>

<GhBugzillaService icon=″bugzillaIcon″

type=″service″ reconstructed=″false″/>

</object>
<name>

<english>Report a bug</english>
<backslang>Gub a troper</backslang>
<hebrew> [symbol] </hebrew>

</name>
<description>

<english>Report a bug to G.ho.st

Bugzilla</english>

<backslang>Gub a troper</backslang>
<hebrew> [symbol] </hebrew>

</description>

</resource>
<Widgets/>
<windowServices/>

</startMenu>
<quickLaunch/>
<objects>

<servicesDirectoryClass x=″200″ y=″200″

GhWindowGID=″2″ opacity=″0″ winState=″dormant″
icon=″servicesDirectoryIcon″ type=″window″ reconstructed=″true″
resizable=″true″ maximized=″false″ allowdrag=″true″/>

<desktopPreferencesClass x=″500″ y=″100″ width=″500″

height=″250″ GhWindowGID=″1″ opacity=″0″ winState=″dormant″
icon=″preferencesIcon″ type=″window″ reconstructed=″true″
resizable=″true″ maximized=″false″ allowdrag=″true″/>

<clockClass x=″300″ y=″400″ width=″500″ height=″250″

type=″widget″ timezone=”GMT+4”/>

</objects>
<folder name=”root”>
<folder name=”my documents”>

<icon caption=”my document 1” icon=”http://...”

OID=”asdfakjf”/>

</folder>
<folder name=”quick launch”>
</folder>
</folder>

</userDesktop>

### Business Method for Virtual Hosted Operating System

Several approaches to financing an operating system are known. The best known model is the license fee charged per user by companies such as Microsoft Corporation, who sell versions of the Windows operating system using a per-seat perpetual license fee. Another model is bundling the operating system with a computer. This method has been practiced by Apple of Cupertino, Calif. who bundle the MacOS together with the Mac computers. It is also practiced by Microsoft's resellers such as Dell Inc. and HP Inc. who sell a Microsoft Windows license bundled with a PC.

Another approach is to provide the operating system for free and develop it using volunteers and or donations. Such is the approach of some of the Unix family of operating systems and Linux. Hybrids of the commercial and free approach are offered by companies such as Red Hat Inc.

In one embodiment a virtual hosted operating system is financed by one of the prior art methods of monthly subscription and/or advertisements placed on the Desktop. However subscriptions would reduce the desirability of the virtual hosted operating system to users who are used to getting free Internet services. Advertisements would reduce the quality of the User experience and also impact desirability.

In another embodiment a basic account is free to the user. The basic account is subsidized by premium accounts which carry a monthly subscription and have extra privileges, such as, but not limited to, larger storage quota for uploaded files and access to extra services. Unfortunately, the basic account does not generate revenue and the premium account may not be popular because of its cost.

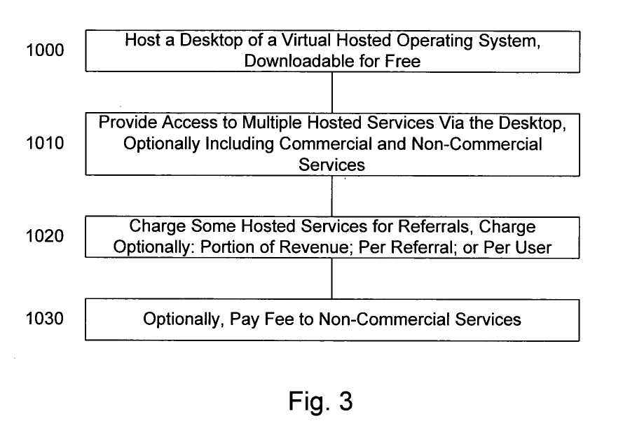

A novel business model is therefore offered according to an aspect of the invention which is uniquely relevant to virtual hosted operating systems, and is illustrated in FIG. 3. This novel business model relies on the unique way in which the virtual hosted operating system is coupled to third-party services such as hosted software applications and in fact the virtual hosted operating system is in a large part aggregating third-party services.

In accordance with an embodiment of the invention, and as illustrated at stage 1000 of FIG. 3, the method of financing comprises hosting a virtual hosted operating system preferably supporting a desktop, and enabling download of the desktop for free or for a price which is reduced to reflect the other revenue sources described herein. According to certain embodiments of the invention, the virtual hosted operating system service provider will charge the third-party service providers a proportion of their own revenue which arises from delivering services over the Desktop of the virtual hosted operating system Client 111 as measured by a third-party activity monitor 850 which may store data on users's third-party activity and especially paid activities in billing data 309, and as illustrated in stage 1020.

Equivalently, the virtual hosted operating system service provider will join “affiliate programs” and receive a proportion of third-party service providers' revenue in return for referring users to the third-party service from the virtual hosted operating system Desktop.

Specifically the charge by the virtual hosted operating system service provider to the third-party service provider for delivering services over the Desktop of the virtual hosted operating system Client will be given by:

S=F×T

### Where

S=Revenue share paid by third-party service provider to operating system provider

F=Share Factor

T=third-party service Provider income.

More specifically, T may be agreed to be one of the following or variations thereof:

Total revenue from services delivered via the virtual hosted operating system;

Gross profit from services delivered via the virtual hosted operating system; and

Any other known accounting measure of value received.

Note that the nature of the revenue includes, but is not limited to, subscriptions, revenue from advertising to the user, referrals to other service providers, and the value of electronic commerce sales (or the associated gross profit).

“Delivering services over the Desktop of the virtual hosted operating system Client” is preferably defined based on any logical combination of the following criteria, and the factor F may be a function of which of these criteria are present:

The service was discovered via the virtual hosted operating system;

The user originally signed-up for the service (‘subscribed’) via the virtual hosted operating system;

The user signed in to this specific session using the virtual hosted operating system Single Sign-On;

The service is running embedded visually e.g. in a window over the virtual hosted operating system Client Desktop;

The service communicated, e.g. sent alerts, to the user via the virtual hosted operating system Desktop; and

The service was listed in directories 170 (where F may be dependent on the size or position or style of the listing).

F is a proportion which is a matter of negotiations and/or which may vary according to the service provider, the service, and even the specific service session instance according to a combination of factors such as:

The scale of services offered by the specific third-party service providers;

The nature of the services (for example F may be higher for services with a higher gross profit margin);

Which of the above criteria apply to the session; and

The important of the specific service to attracting new users to the virtual hosted operating system.

In one embodiment the virtual hosted operating system includes as one of its services a billing service 350 for billing users and the virtual hosted operating system service provider provides the service of collecting subscription and license payments for third-party service providers and passes on those payments net of the revenue share.

According to a preferred embodiment some free, i.e. non-revenue generating, applications are offered via the virtual hosted operating system, as illustrated in stage 1010, as these help to increase the utility of the virtual hosted operating system to users even if the free applications do not directly generate revenue for the virtual hosted operating system. Further according to a preferred embodiment, in order to encourage service providers to offer free services, in one embodiment the virtual hosted operating system service provider may pay free third-party service providers a fee for offering their services, as illustrated in stage 1030.

According to a preferred embodiment the virtual hosted operating system will pay free third-party service providers a proportion of its own revenue, or gross profit where such proportion may be responsive to e.g. the number of users using that service, the number of hours they spend using it or the ratings users attach to the service. Thus, the present embodiments enable a virtual hosted operating system which is virtual in the sense that the main resources available to the user within the operating system are actually hosted by third-parties not directly related to the virtual hosted operating system and are nonetheless aggregated by the virtual hosted operating system in such as a way as to give the user a seamless experience using these resources just as easily as if they were all hosted by the same service provider or even as easily as if they were all installed on the user's physical computer.

The present embodiments further provide a business method specifically suitable for financing the virtual hosted operating system.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

The terms “include”, “comprise” and “have” and their conjugates as used herein mean “including but not necessarily limited to”.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

I claim:

1. A virtual hosted operating system comprising:
a data center; and
a client code downloaded from the data center to a terminal for rendering a user desktop,
wherein said downloaded client code is operative to:
launch a plurality of third-party web applications; and
visually couple said third-party web applications to the user desktop,
and wherein said data center is operative to perform authentication to at least one of said plurality of third-party web applications.

2. The virtual hosted operating system of claim 1 where the client code is downloaded dynamically to a browser running on said terminal and executed inside the browser.

3. The virtual hosted operating system of claim 1, wherein said data center includes a repository of user's login credential to third party web sites.

4. The virtual hosted operating system of claim 3, wherein said data center further comprises a single-sign-on functionality operative to automatically authenticate a user to third-party web services hosting said third party web applications.

5. The virtual hosted operating system of claim 1, wherein said client code comprises a browser-within-a-web-page.

6. The virtual hosted operating system of claim 4, wherein said data center comprises a proxy server functionality, and wherein the browser-within-a-web-page communicates with said third-party web applications via said proxy server.

7. The virtual hosted operating system of claim 6, where the proxy server functionality comprises a cookies store, and said proxy server is operative to store cookies from said third party web applications in said cookies store.

8. The virtual hosted operating system of claim 1, wherein said client code is further operative to provide a virtual file system providing consistent access within the desktop to a plurality of technically incompatible hosted file systems.

9. The virtual hosted operating system of claim 8, wherein said client code is further operative to mount a hosted file system as a drive.

10. The virtual hosted operating system of claim 9, wherein said client code comprises a federated general object graph operative to allow the user to navigate disparate third-party data sources.

11. The virtual hosted operating system of claim 1, including a persistence service operative to capture and reconstitute the state of the client code.

12. The virtual hosted operating system of claim 11, where third-party applications may store data in the persistence service.

13. A business method for financing a virtual hosted operating system comprising:
hosting a desktop program which may be downloaded free-of-charge by users;
allowing users to access multiple hosted services referred via the desktop; and
charging at least one hosted service for receiving referrals.

14. A business method according to claim 13, where the hosted services includes at least one commercial service and at least one non-commercial service, and wherein the at least one hosted service which is charged is said at least one commercial service.

15. A business method according to claim 14, wherein the charge is a proportion of a measure of the revenue of the at least one hosted service.

16. A business method according to claim 14, where the charge is per referral.

17. A business method according to claim 14, where the charge is per unique user referred.

18. A business method according to claim 14, where a proportion of the charge is paid to at least one non-commercial service.

19. A business method according to claim 14, where a proportion of the charge is paid to at least one contributor to the hosted operating system technology or a provider of a free service.

20. A system for administering the finances of a hosted operating system comprising:
a hosted desktop program which may be downloaded free-of-charge by users;
a mechanism for referring users from the desktop program to at least two third-party hosted services; and
a billing system which charges the at least two hosted services for receiving referrals.

21. A method of implementing a virtual hosted operating system, the method comprising:
providing a downloadable client code at a data center, said client code being operative to:
render a user desktop on a terminal to which it has been downloaded;
launch a plurality of third-party web applications; and
visually couple said third-party web applications to the user desktop, and
performing automatic authentication from the data center to at least one of said plurality of third-party web applications.

22. A method according to claim 21, further comprising:
dynamically downloading said client code to a browser; and
executing said client code inside the browser.

23. A method according to claim 21, further comprising:
storing, at the data center, a repository of user's login credential to third party web sites, said preformed automatic authentication being responsive to said stored repository.

24. A method according to claim 21, wherein said client code comprises a browser-within-a-web-page.

25. A method according to claim 24, further comprising:
providing, at the data center, a proxy server functionality;
communicating between said browser-within-a-web-page and said third-party web applications via said proxy server.

26. A method according to claim 25, further comprising:
storing, at the data center, cookies from said third party web applications.

27. A method according to claim 21, wherein said client code is further operative to provide a virtual file system providing consistent access within the desktop to a plurality of technically incompatible hosted file systems.

28. A method according to claim 27, wherein said client code is further operative to mount a hosted file system as a drive.

29. A method according to claim 28, wherein said client code comprises a federated general object graph operative to allow the user to navigate disparate third-party data sources.

30. A method according to claim 21, further comprising:
capturing and reconstituting the state of the client code.

31. A method according to claim 30, further comprising:
storing, at the data center, data from said third party web applications.
